(19) United States
(12) Patent Application Publication
(10) Pub. No.: US 2011/0101556 A1
(43) Pub. Date: May 5, 2011

(54) METHOD AND HEATING DEVICE FOR THERMOFORMING

(76) Inventors: Sascha Bach, Dresden (DE); Tilo Hanke, Dresden (DE)

(21) Appl. No.: 12/994,929

(22) PCT Filed: May 20, 2009
(86) PCT No.: PCT/DE2009/000708

§ 371 Date: Jan. 21, 2011

(30) Foreign Application Priority Data
May 29, 2008 (DE) 10 2008 025 832.6
Dec. 13, 2008 (DE) 10 2008 062 199.4

(51) Int. Cl. B29C 51/42; B29C 51/10; B29C 51/46; B29B 13/02

(52) U.S. Cl. 264/40.6; 264/544

(57) ABSTRACT

The present invention relates to a method and a heating device for thermoforming thermoplastic semi-finished products. According to the method locally different thermoforming behaviour during shaping to give a three-dimensional moulded part is achieved by locally different heating of the semi-finished product (1). Two contact heating devices (2) are used for the heating of the semi-finished product (1) and are brought into contact with the semi-finished product (1) simultaneously from opposing sides. Each contact heating device (2) comprises an individual heating circuit (6) formed of a ceramic heating layer on a thermally-insulating support (7), the locally different heating being achieved by means of a locally differing geometrical design of the heating circuits (6) on the support (7). The method and the heating device permit selective control of the wall thickness distribution in the moulded part to be produced without the use of prestretching male moulds or radiant heaters.

### TECHNICAL FIELD OF APPLICATION

The present invention relates to a method for heating thermoplastic semi-finished products during thermoforming, in which the semi-finished product is heated to the thermoforming temperature, shaped to form a three-dimensional moulded part by applying a differential pressure between the upper face of the semi-finished product and the underside of the semi-finished product, and then cooled with in-mould constraint, locally different heating of the semi-finished product before the shaping process resulting in a locally different thermoforming behaviour. The invention also relates to a heating device for carrying out the method.

In thermoforming a thermoplastic semi-finished product is placed in a defined three-dimensional mould. For shaping the semi-finished product has to be heated at least to the thermoforming temperature, at which the material exhibits behaviour suitable for shaping. The thermoforming process itself is carried out by a pressure differential between the upper face of the semi-finished product and the underside of the semi-finished product and, depending on the true strain, also by additional mechanical prestretching. The pressure differential is produced by the use of compressed air and/or a vacuum. After shaping, the semi-finished product is cooled. Plastics material films or plastics material sheets are generally used as semi-finished products.

### PRIOR ART

With some three-dimensional moulds it is necessary, during the process of shaping, to achieve a locally different thermoforming behaviour or a specific wall thickness distribution in the moulded part in order to counteract, for example, undesired thinning at the corners or edges of the moulded part to be produced. The aim is to thereby ensure the desired stability and integrity of the moulded part. The material properties and therefore also the thermoforming behaviour of the thermoplastic material change depending on temperature. Uneven thermoforming behaviour, which can be used to control the material distribution at the moulded part to be produced, can be selectively produced during heating as a result of an uneven temperature field.

For smaller moulds the semi-finished product is generally warmed or heated by contact heating. As a result of the difficulty of heat conduction within the heating tool, in particular when working with small forming geometries, this type of heating of the semi-finished product using direct thermal contact did not previously make it possible to provide selective and controllable uneven heating in order to achieve locally different thermoforming behaviour. Prestretching male moulds are therefore predominantly used to influence the wall thickness distribution at the moulded part to be produced. These male moulds can be used to achieve defined local cooling in those regions that are to be deformed to a lesser extent as a result of the direct contact of the heated semi-finished product with the male mould. The semi-finished product is furthermore prestretched by the movement of the male mould, which has a significant effect on wall thickness distribution. The final moulding step is achieved by applying a differential pressure, i.e. overpressure, vacuum or both.

A method and device for pneumatic thermoforming of plastics material products are known from DE 103 49 156 A1. In the method the thermoforming behaviour of the semi-finished product is influenced locally by additional application, in selected partial regions, of a radiation of increasing temperature before and/or during forming, in such a way that the wall thickness distribution in the moulded part produced can thus be influenced. For example a laser, particularly a CO₂ laser is used for the radiation of increasing temperature. However, in this instance the radiation used must be adjusted to the absorbency of the semi-finished product material. The use of a laser furthermore generally requires an additional scanner, which guides the laser beam over the regions to be heated to a selectively greater extent.

DE 10 2005 018 652 A describes a device for heating flat objects by a large number of heat sources arranged beside one another in a grid-like manner. The heat sources are configured as point radiant heaters—the necessary heat is thus produced via thermal radiation. The radiant heaters are individually controllable, therefore flexible local heating can be achieved. The power of the heater must also be adjusted to absorbency. Furthermore, partial preheating with creation of a temperature profile within the region to be formed is not possible with this device when working with small forming geometries. The granularity of the source matrix is predetermined by the size of the radiation source. In addition, the heating region can be scaled by special hotplate configurations, however this is very problematic for the simultaneous heating of a plurality of cavities.

WO 2008/034624 A1 describes a hotplate for the preheating and sealing of film webs during thermoforming. Heating adapted to the film web thus takes place by the principle of thermal contact, which makes it possible to improve the forming result. This hot plate is characterised by a large number of heating means arranged within the heating tool that are controllable via the power supply with regard to the temperature to be set and are additionally adjustable by the integration of temperature controls. A drawback of this principle is the thermal coupling of the heating means by the arrangement within a heating tool, which makes it impossible to produce considerable temperature gradients over a small area, this being necessary particularly when working with smaller forming geometries.

The object of the present invention consists of providing a method and a heating device for thermoforming, with which it is possible to achieve locally different thermoforming behaviour in the semi-finished product without prestretching male moulds, even when working with smaller and medium-sized forming geometries, with a finely adjustable temperature distribution within the semi-finished product, and which do not require any adjustment to the absorbency of the semi-finished product.

### ILLUSTRATION OF THE INVENTION

The object is achieved with the method and heating device according to claims 1 and 4. Advantageous configurations of the method and heating device are the subject of the dependent claims or can be inferred from the following description and embodiments.

In the proposed method for thermoforming thermoplastic semi-finished products the semi-finished products are heated to the thermoforming temperature, shaped to form a three-dimensional moulded part by applying a differential pressure between the upper face and the underside of the semi-finished product, and then cooled with in-mould constraint, locally different heating of the semi-finished product before and/or during the shaping process resulting in a locally different thermoforming behaviour. In this instance the thermoforming temperature is understood to be the temperature range in which the material can be formed. During thermoforming the thermoforming temperature lies below the flow temperature of the plastics material, the plastics material still being relatively dimensionally stable, but can also be plastically deformed by the effects of small forces. The forming process itself can be carried out using known methods, in particular by vacuum forming or pressure forming or by a combination of the two methods. The same methods can also be used to ensure in-mould constraint during the cooling phase. The proposed method is characterised in that the moulded part is heated by thermal contact heating, in which two contact heating devices are used that are brought into contact simultaneously with the semi-finished product from opposing sides. Each contact heating device comprises a single planar heating circuit formed of a ceramic heating layer on a thermally-insulating support. The heating circuits are formed on the face of the support in such a way that they emit a locally different heating power over this face. This is achieved by the geometric configuration and/or distribution of the respective heating circuit on this face. For example a ceramic plate can be used as the support.

The heating device configured for carrying out the method and for heating an introduced semi-finished product to the thermoforming temperature, which device is followed by a thermoforming station for forming the heated semi-finished product to form a three-dimensional moulded part during thermoforming, is formed by two contact heating devices that can be brought into contact simultaneously with the semi-finished product from opposing sides. Each contact heating device comprises a single heating circuit formed of a ceramic heating layer on a thermally-insulating support. The heating circuits are formed on the face of the support in such a way that they emit a locally different heating power over this face.

On the one hand, undesired heat conduction during the heating phase over the support can be largely avoided by using contact heating devices, each with an individual planar heating circuit that is formed of a ceramic heating layer and is applied to a thermally-insulating support. On the other hand this makes it possible to achieve selective control of the temperature distribution during heating by selective uneven distribution or geometric configuration of the heating circuit on the face of the support provided for this. The practically freely selectable shaping of the ceramic heating layers forming the heating circuits and therefore the heating power over this face (thermal image) makes it possible to selectively predetermine the introduction of heat into the respective semi-finished product. The heating layers are particularly advantageously imprinted as a thin layer in the geometrical form of the desired heating circuits. Highly dynamic temperature control is possible as a result of the comparatively small cross-section of the heating ceramics and the thermal decoupling of the heating layers from the support. The design of the layout of the heating circuit results in the desired uneven temperature distribution.

The proposed method and the associated heating device make it possible to selectively influence the wall thickness distribution during the shaping process as a result of the partial heating of the thermoplastic material. The use of prestretching male moulds can also be dispensed with completely. The wall thickness distribution is primarily controlled by the temperature distribution over the heating regions. Furthermore, the energy efficiency of the heating process can be improved by selective energy transmission. This is achieved in that heating is only effected during direct contact with the semi-finished product. The heating circuits are designed in such a way that they only heat the region to be formed. Furthermore, the contact between the heating circuits and the semi-finished product results in a direct transfer of heat. Compared to a thermoforming process carried out by radiant heaters, the absorbency of the thermoplastic semi-finished product is irrelevant. In the proposed method, merely when designing the heating circuits, the position and size of the heating lines or heating circuits must be selected in such a way that the respective heating power can be achieved at the desired positions. This can be mathematically simulated beforehand. The versatility of the design is merely restricted by physical limitations. The heating lines exhibit low thermal capacity as a result of the small cross-section of the heating lines and the thermal decoupling from the support. Highly efficient and highly dynamic temperature control is thus possible when heating the semi-finished product.

In an advantageous configuration the temperature-dependent resistance of the heating circuits is used for temperature measurement and control. This utilisation of the temperature dependency of the electric resistance of the heating circuit as a measured variable for semi-finished product temperature makes it possible to dispense with the use of temperature sensors for the control system. The introduction of thermal energy can thus be measured and controlled directly via the control system or adjusted so as to observe a local setpoint temperature. This is achieved by an appropriately configured control device that measures the resistance of the heating circuit (measurement of current I and voltage U) and controls the respective heating circuit based on this measurement so that it emits the heating power required to reach or maintain a specific temperature of the semi-finished product. The heating device can also be operated as an impulse heater in the method.

In the present method or present heating device the thermally-insulating support can be made, for example, of ceramics (for example Al₂O₃, AlN, Si₃N₄), quartz or glass ceramics. For example Mo silicides or RuO₂ can be used as materials for the ceramic heating layers. For example the thickness of these heating layers may lie in a range between 2 and 100 μm. The heating layers can be applied to the support directly or via an intermediate layer, for example a ceramic intermediate layer.

The use of imprintable or imprinted ceramic heating layers also poses specific advantages during production, although other methods for applying the heating circuits can, of course, also be used with relinquishment of these advantages.

### BRIEF DESCRIPTION OF THE DRAWINGS

The proposed method and the associated heating device will again be briefly described hereinafter with reference to embodiments and in conjunction with the drawings, in which:

FIG. 1 is a schematic illustration of an example of a heating device and a thermoforming station connected thereto for thermoforming; and

FIG. 2 shows an example of a configuration of the contact heating devices.

### EMBODIMENTS OF THE INVENTION

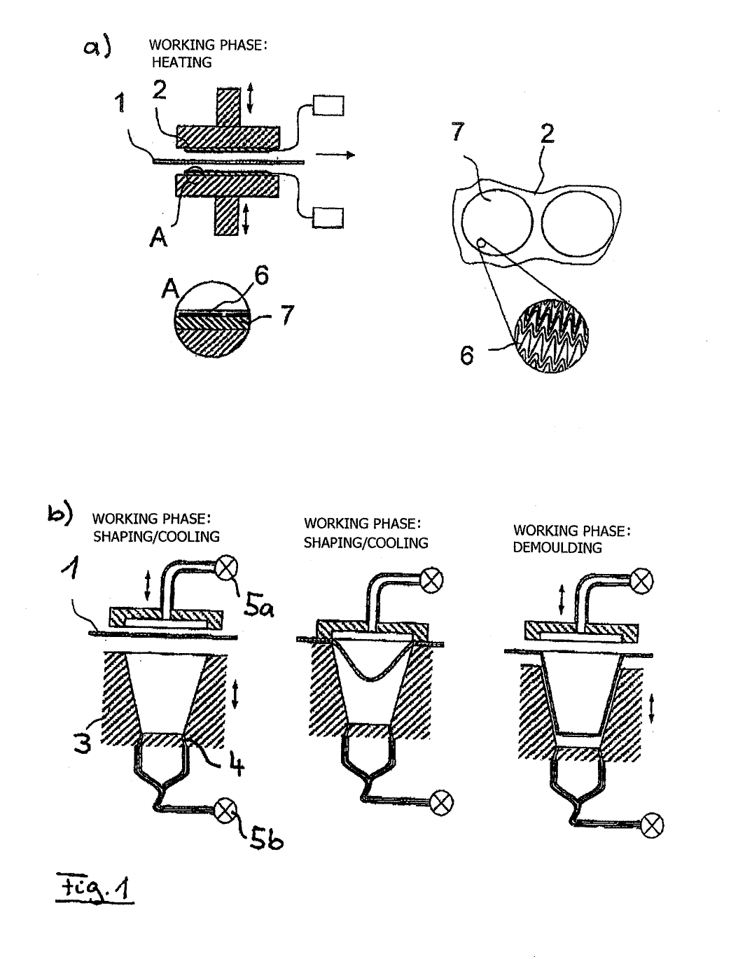

FIG. 1 is a highly schematic view of an example of a configuration of the proposed heating device for thermoforming. FIG. 1a shows the heating station or heating device and FIG. 1b shows the thermoforming station, which follows the heating station. The thermoforming station is shown in three working phases. In this instance the main part of the invention is carried out in the heating station. The illustration of the thermoforming station is given in order to illustrate the forming process without the use of prestretching male moulds. A mould 3 is basically shown comprising runners 4 in the base region that are connected to a vacuum pump 5b, and a mould upper part that is connected to a compressed air supply 5a.

The semi-finished product 1 to be formed, in this example a thin sheet of a thermoplastic polymer, is positioned in the heating station, as shown in FIG. 1. The hotplates 2 are brought into contact simultaneously with the semi-finished product 1 from either side in order to heat this semi-finished product 1 to the thermoforming temperature. The hotplates 2 are configured in such a way that they supply a low heating power in the regions of the semi-finished product 1 that will later lie against the lower corners of the mould 3. Low material flow during the forming process is thus obtained in these regions so that greater wall thickness can be selectively achieved there. Each of the hotplates 2 comprises only a single heating circuit formed of a ceramic heating layer that is configured in its layout in such a way that the desired local temperature distribution in the semi-finished product 1 is obtained. In the enlarged detail A of FIG. 1a, the ceramic heating layer forming the heating circuit 6 can be seen on the thermally-insulating support 7. The right-hand part of FIG. 1a shows a detailed plan view of the hotplate 2.

After heating of the semi-finished product by thermal contact with the hotplates 2, the semi-finished product 1 is positioned in the thermoforming station. A vacuum is generated in the cavity of the mould 3 arranged beneath the semi-finished product 1 via the vacuum pump 5b, as a result of which vacuum the semi-finished product 1 is sucked against the inner wall of the mould 3 (see FIG. 1b). An overpressure is simultaneously applied above the semi-finished product 1 via the compressed air supply 5a and assists with the forming process. After this process the semi-finished product 1 is cooled in this mould whilst maintaining the suction effect and the overpressure in such a way that cooling is carried out with in-mould constraint. After cooling the finished moulded part can be removed from the mould 3.

In the proposed method the locally different heating of the semi-finished product is achieved using thermal contact heating by a suitable, uneven distribution of the respective heating circuit over the face of the hotplate.

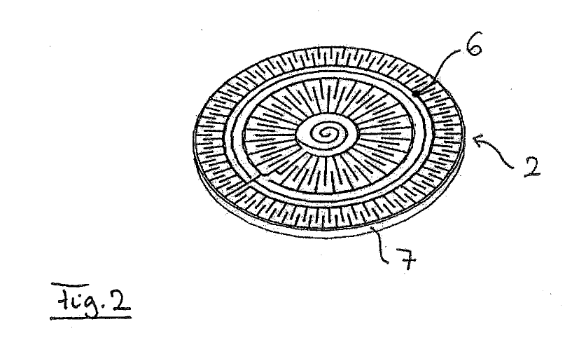

FIG. 2 shows an example of a hotplate 2, on which a single ceramic heating circuit 6 is applied to the ceramic support 7. The heating circuit 6 generates different temperatures in different regions as a result of the distribution over the face of the support 7. The desired temperature distribution can be achieved at any time by a suitable layout of the heating lines of the heating circuit on the support 7. If a further temperature distribution is desired, a further hotplate 2 is used with a further geometric distribution of the heating lines of the heating circuit 6.

### LIST OF REFERENCE NUMERALS

1 semi-finished product
2 hotplate
3 mould
4 runner
5a compressed air supply
5b vacuum pump
6 heating circuit
7 support

1. A method for thermoforming thermoplastic semi-finished products, in which the semi-finished product (1) is heated to the thermoforming temperature, shaped to form a three-dimensional moulded part by applying a differential pressure between an upper face of the semi-finished product and an underside of the semi-finished product, and then cooled with in-mould constraint,
locally different heating of the semi-finished product (1) before the shaping process resulting in a locally different thermoforming behaviour,
characterised in that
two contact heating devices (2) are used to heat the semi-finished product (1) that are brought into contact simultaneously with the semi-finished product from opposing sides,
each contact heating device comprising a single heating circuit (6) formed of a ceramic heating layer on a thermally-insulating support (7) and the locally different heating being achieved by a locally different geometrical design of the heating circuits (6) on the support (7).

2. The method according to claim 1,
characterised in that
an electric resistance of the heating circuits (6) is measured during the heating process and is used to ascertain and control a temperature at the semi-finished product (1).

3. The method according to either claim 1 or claim 2,
characterised in that
the heating circuits (6) are operated in a pulsed manner.

4. A heating device for carrying out the method according to any one of claims 1 to 2, which device is formed by two contact heating devices (2) that can be brought into contact simultaneously with the semi-finished product from opposing sides,
each contact heating device comprising a single heating circuit (6) formed of a ceramic heating layer on a thermally-insulating support (7) and the heating circuits (6) being formed on a face of the support (7) in such a way that they emit a locally different heating power over this face.

5. The heating device according to claim 4,
characterised in that
the heating circuits (6) are imprinted on the support (7).

6. The heating device according to claim 4,
characterised in that
the heating device comprises a control device with a control that ascertains a temperature at the semi-finished product (1) via an electric resistance of one or both heating circuits (6) during the heating process and adjusts the temperature to a setpoint temperature by controlling the heating circuits.
